(19) United States
(12) Patent Application Publication
(10) Pub. No.: US 2019/0138901 A1
(43) Pub. Date: May 9, 2019

(54) TECHNIQUES FOR DESIGNING ARTIFICIAL NEURAL NETWORKS

(71) Applicant: THE ROYAL INSTITUTION FOR THE ADVANCEMENT OF LEARNING/MCGILL UNIVERSITY, Montreal (CA)

(72) Inventors: Brett MEYER, Cote-St-Luc (CA); Warren GROSS, Cote-St-Luc (CA); Sean SMITHSON, Pierrefonds (CA)

(21) Appl. No.: 16/182,103

(22) Filed: Nov. 6, 2018

Related U.S. Application Data
(60) Provisional application No. 62/581,946, filed on Nov. 6, 2017.

(51) Int. Cl. G06N 3/08

(52) U.S. Cl. CPC G06N 3/08

(57) ABSTRACT

Systems and methods for identifying at least one neural network suitable for a given application are provided. A candidate set of neural network parameters associated with a candidate neural network is selected. At least one performance characteristic of the candidate neural network is predicted. The at least one performance characteristic of the candidate neural network is compared against a current performance baseline. When the at least one performance characteristic exceeds the current performance baseline, using a predetermined training dataset is used to train and test the candidate neural network for identifying the at least one suitable neural network.

### CROSS-REFERENCE TO RELATED APPLICATIONS

The present application claims priority under 35 U.S.C. 119(e) of Provisional Patent Application bearing serial No. 62/581,946 filed on Nov. 6, 2017, the contents of which are hereby incorporated by reference.

### TECHNICAL FIELD

The present disclosure relates to the use of neural networks and other learning techniques in designing further neural networks.

### BACKGROUND OF THE ART

Artificial neural networks have gone through a recent rise in popularity, achieving state-of-the-art results in various fields, including image classification, speech recognition, and automated control. Both the performance and computational complexity of such models are heavily dependent on the design of characteristic hyper-parameters (e.g., number of hidden layers, nodes per layer, or choice of activation functions), which have traditionally been optimized manually. With machine learning penetrating low-power mobile and embedded areas, the need to optimize not only for performance (accuracy), but also for implementation complexity, becomes paramount.

Given spaces which can easily exceed 10²⁰ solutions, manually designing a near-optimal architecture is unlikely as opportunities to reduce network complexity, while maintaining performance, may be overlooked. This problem is exacerbated by the fact that hyper-parameters which perform well on specific datasets may yield sub-par results on others, and must therefore be designed on a per-application basis.

As such, there is a need for techniques which facilitate the optimization of neural networks.

### SUMMARY

There is provided a multi-objective design space exploration method that may assist in reducing the number of solution networks trained and evaluated through response surface modelling. Machine learning is leveraged by training an artificial neural network to predict the performance of future candidate networks. The method may be used to evaluate standard image datasets, optimizing for both recognition accuracy and computational complexity. Certain experimental results demonstrate that the proposed method can closely approximate the Pareto-optimal front, while only exploring a small fraction of the design space.

In accordance with a broad aspect, there is provided a method for identifying at least one neural network suitable for a given application. A candidate set of neural network parameters associated with a candidate neural network is selected. At least one performance characteristic of the candidate neural network is predicted. The at least one performance characteristic of the candidate neural network is compared against a current performance baseline. When the at least one performance characteristic exceeds the current performance baseline, a predetermined training dataset is used to train and test the candidate neural network for identifying the at least one suitable neural network.

In accordance with another broad aspect, there is provided a system for identifying at least one neural network suitable for a given application. The system comprises a processing unit and a non-transitory computer-readable memory communicatively coupled to the processing unit and comprising computer-readable program instructions executable by the processing unit for selecting a candidate set of neural network parameters associated with a candidate neural network, predicting at least one performance characteristic of the candidate neural network, comparing the at least one performance characteristic of the candidate neural network against a current performance baseline, and when the at least one performance characteristic exceeds the current performance baseline, using a predetermined training dataset for training and testing the candidate neural network to identify the at least one suitable neural network.

### BRIEF DESCRIPTION OF THE DRAWINGS

Further features and advantages of the present invention will become apparent from the following detailed description, taken in combination with the appended drawings, in which:

FIG. 1 is a flowchart of an example method for identifying a neural network suitable for a given application.

FIG. 2 is a block diagram illustrating an example computer for implementing the method of FIG. 1.

FIG. 3 is a graph illustrating example experimental results.

It will be noted that throughout the appended drawings, like features are identified by like reference numerals.

### DETAILED DESCRIPTION

Artificial neural network (ANN) models have become widely adopted as means to implement many machine learning algorithms and represent the state-of-the-art for many image and speech recognition applications. As the application space for ANNs evolves beyond workstations and data centers towards low-power mobile and embedded platforms, the design methodologies also evolve. Mobile voice recognition systems currently remain too computationally demanding to execute locally on a handset. Instead, such applications are processed remotely and, depending on network conditions, are subject to variations in performance and delay. ANNs are also finding application in other emerging areas, such as autonomous vehicle localization and control, where meeting power and cost requirements is paramount.

With the proliferation of machine learning on embedded and mobile devices, ANN application designers must now deal with stringent requirements regarding various performance characteristics, including power and cost requirements. These added constraints transform the task of designing the parameters of an ANN, sometimes called hyper-parameter design, into a multi-objective optimization problem where no single optimal solution exists. Instead, the set of points which are not dominated by any other solution forms a Pareto-optimal front. Simply put, this set includes all solutions for which no other is objectively superior in all criteria.

Herein provided are methods and systems which, according to certain embodiments, may be used to train a modelling ANN to design other ANN. In one embodiment, the ANNs referred to herein are deep neural networks (DNNs). As used herein, a modelling ANN is an ANN that is trained to estimate one or more performance characteristics of a candidate ANN, and may be used for optimizing for one or more performance characteristics, including error (or accuracy) and at least one of computation time, latency, energy efficiency, implementation cost (e.g., time, hardware, power, etc.), computational complexity, and the like. As used herein, a candidate ANN refers to an ANN which has an unknown degree of suitability for a particular application. According to certain embodiments, a meta-heuristic modelling ANN exploits machine learning to predict the performance of candidate ANNs (modelling the response surface), learning which points to explore and avoid the lengthy computations involved in evaluating solutions which are predicted to be unfit. In particular, the modelling ANN treats the performance characteristics of the candidate ANNs as objectives to be minimized or constraints to be satisfied and models the response surface relating hyper-parameters and accuracy, and optionally other predicted performance characteristics. According to certain embodiments, response surface modelling (RSM) techniques are leveraged to assist in reducing proposed algorithm run-time, which may ultimately result in the reduction of product design time, application time-to-market, and overall non-recurring engineering costs. In some embodiments, other machine learning techniques are used instead of the modelling ANN to design the other ANN. For example, Bayesian optimization, function approximation, and other learning and meta-learning algorithms are also considered.

In addition, herein provided are methods and systems which, according to certain embodiment, present a design-space exploration approach that searches for Pareto-optimal parameter configurations which may be applied to both multi-layer perceptron (MLP) and convolutional neural network (CNN) ANN topologies. The design space may be confined to ANN hyper-parameters including, but not limited to, the numbers of fully-connected (FC) and convolutional layers, the number of nodes or filters in each layer, the convolution kernel sizes, the max-pooling sizes, the type of activation function, and network training rate. These degrees of freedom constitute vast design spaces and all strongly influence the performance characteristics of resulting ANNs.

For design spaces of such size, performing an exhaustive search is intractable (designs with over 10¹⁰ to 10²⁰ possible solutions are not uncommon), therefore the response surface is modelled using the modelling ANN for regression where the set of explored solution points is used as a training set. The presented meta-heuristic modelling ANN is then used to predict the performance of candidate networks, and only candidate ANNs which are expected not to be Pareto-dominated, that is to say which exceed a current Pareto-optimal front, are explored.

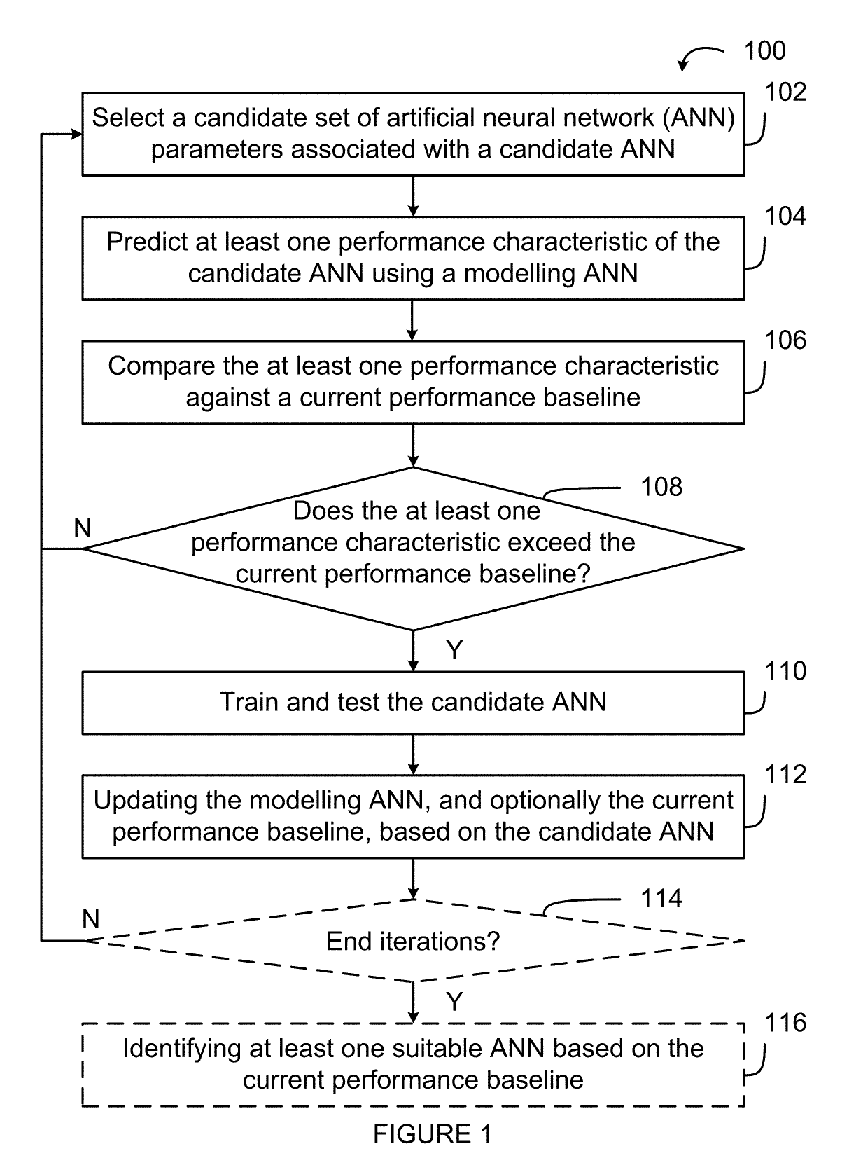

With reference to FIG. 1, there is provided a method 100 for identifying an ANN suitable for a given application. It should be noted that the method 100 may, in whole or in part, be implemented iteratively, and certain steps may be implemented differently when they are performed for the first time in a particular set of iterations than when they are performed during later iterations. In addition, the method 100 may be preceded by various setup and fact-finding steps, for instance the generation of a corpus of data for training the eventual suitable ANN, the establishment of one or more parameters for the ANN, the setting of a maximum iterations count or some other end condition, and the like.

At step 102, a candidate set of ANN parameters (e.g., hyper-parameters), associated with a candidate ANN, is selected. When step 102 is first performed, or the first few times step 102 is performed, the candidate set of ANN parameters may be selected at random, based on predetermined baseline values for the ANN parameters, or in any other suitable fashion. In some embodiments, the candidate sets of ANN parameters are selected at random for a predetermined number of first iterations. When step 102 is performed as part of later iterations, the candidate sets of ANN parameters may be selected by the modelling ANN. In some embodiments, a subsequent candidate set of ANN parameters varies only one parameter from a preceding candidate set of ANN parameters. In other embodiments, a subsequent candidate set of ANN parameters varies a plurality of parameters vis-à-vis the preceding candidate set of ANN parameters.

At step 104, at least one performance characteristic of the candidate ANN is predicted, given the candidate set of ANN parameters. The at least one performance characteristic is predicted using the modelling ANN. The modelling ANN uses the candidate set of ANN parameters associated with the candidate ANN to predict one or more performance characteristics discussed herein above, including average error and at least one of computation time, energy efficiency, implementation cost, and the like. In some embodiments, some of the performance characteristics of the candidate ANN may be evaluated directly, without the use of the modelling ANN. For example, it may be possible to evaluate the implementation cost of the candidate ANN from the candidate set of ANN parameters using one or more algorithms which do not require the modelling ANN.

At step 106, the at least one performance characteristic is compared against a current performance baseline, which may be a current Pareto-optimal front composed of one or more performance characteristics for previously-evaluated candidate ANNs. For example, at step 104, the average error and cost for the candidate ANN are determined, and at step 106, the candidate ANN is mapped in a two-dimensional space with other previously evaluated candidate ANN(s).

At step 108, an evaluation is made regarding whether the at least one performance characteristic of the candidate ANN exceeds the current performance baseline. If the candidate ANN has performance characteristics that exceed the current performance baseline (i.e. the candidate ANN outperforms previously-evaluated ANN configurations and is thus not dominated by any other solution), the method 100 moves to step 110. If the candidate ANN does not have performance characteristics which exceed the current performance baseline, the candidate ANN is rejected, and the method 100 returns to step 102 to evaluate a new candidate ANN. It should be noted that in a first iteration of the method 100, the first evaluated candidate ANN forms the first version of the performance baseline, so the first candidate ANN may automatically be accepted.

At step 110, the candidate ANN is trained with corpus of data and tested to obtain actual performance characteristics. The training and testing of the candidate ANN may be performed in any suitable fashion.

At step 112, the modelling ANN, and optionally the current performance baseline, are updated based on the candidate ANN. The modelling ANN is updated based on the candidate set of parameters for the candidate ANN and the actual performance characteristics, in order to teach the modelling ANN about the relationship therebetween. In some embodiments, step 112 includes retraining the modelling ANN with the actual performance characteristics of the candidate ANN, as well as with any other actual performance characteristics obtained from previous candidate ANN. In addition, the current performance baseline is optionally updated based on the candidate ANN: if the actual performance characteristics of the candidate ANN do exceed the current performance baseline, then the performance baseline is updated to include the candidate ANN.

Optionally, at step 114, a determination is made regarding whether an end condition is reached, for example a maximum number of iterations, a targeted number of ANN configurations has been evaluated, a time budged for exploration has been consumed, and/or the modelling ANN has failed to successfully identify a non-dominated configuration. If no end condition has been reached, the method 100 returns to step 102 to select a subsequent candidate ANN with a subsequent candidate set of ANN parameters. If an end condition has been reached, the method 100 proceeds to step 116.

At step 116, at least one suitable ANN is identified based on the current performance baseline. Because the performance baseline is updated in response to every candidate ANN which has actual performance characteristics which exceed a previous performance baseline, the current performance baseline is a collection of candidate ANNs having the most ideal performance characteristic(s). For example, in embodiments where the performance baseline is a Pareto-optimal front, one or more equivalent ANNs form the Pareto-optimal front and are identified as suitable ANNs at step 116.

In accordance with certain embodiments, a particular sampling strategy proposed, which may be implemented by the modelling ANN at step 102, is an adaptation of the Metropolis-Hastings algorithm. In each iteration a new candidate is sampled from a Gaussian distribution centered around the previously explored solution point. Performing this random walk may limit the number of samples chosen from areas of the design space that are known to contain unfit solutions, thereby reducing wasted exploration effort.

In certain embodiments, the modelling ANN models the response surface using an MLP model with an input set representative of ANN hyper-parameters and a single output trained to predict the error of corresponding ANN. This RSM ANN is composed of two hidden rectified linear unit (ReLU) layers and a linear output layer. In one particular example, experimental results were obtained with sizing the hidden layers with 25-times to 30-times the number of input nodes.

The RSM network inputs are formed as arrays characterizing all explored dimensions. Integer input parameters (such as number of nodes in a hidden layer, or size of the convolutional kernels) are scaled by the maximum possible value of the respective parameter, resulting in normalized variables between 0 and 1. For each parameter that represents a choice where the options have no numerical relation to each other (such as whether ReLU or sigmoid functions are used), an input mode is added and the node that represents the chosen option is given an input value of 1 with all other nodes being given an input value of −1. For example, a solution with two hidden layers with 20 nodes each (assuming a maximum of 100), using ReLUs (with the other option being sigmoid functions) and with a learning rate of 0.5 would be presented as input values: [0.2, 0.2, 1, −1, 0.5].

Continuing the aforementioned example, the RSM model was trained using stochastic gradient descent (SGD), where 100 training epochs were performed on the set of explored solutions each time the next is evaluated (and in turn, added to the training set). The learning rate was kept constant, with a value of 0.1, in order to train the network quickly during early exploration, when the set of evaluated solutions is limited.

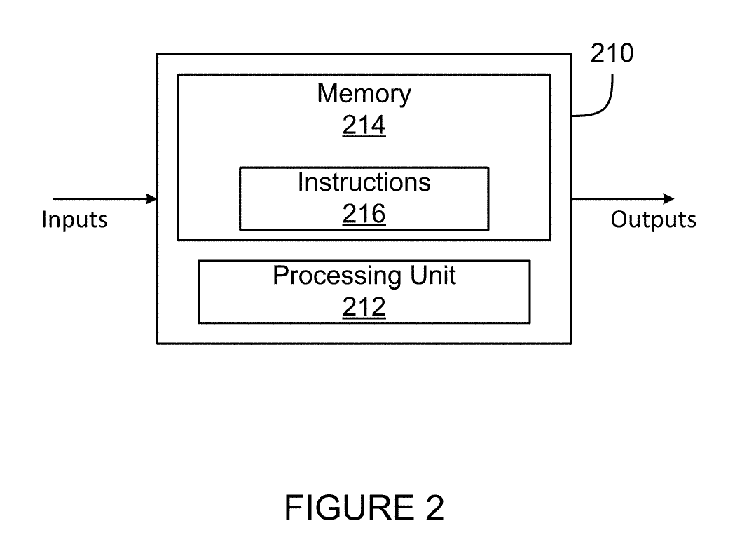

With reference to FIG. 2, the method 100 may be implemented by a computing device 210, comprising a processing unit 212 and a memory 214 which has stored therein computer-executable instructions 216. The processing unit 212 may comprise any suitable devices configured to implement the method 200 such that instructions 216, when executed by the computing device 210 or other programmable apparatus, may cause the functions/acts/steps of the method 200 described herein to be executed. The processing unit 212 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 214 may comprise any suitable known or other machine-readable storage medium. The memory 214 may comprise non-transitory computer readable storage medium, for example, but not limited to, an electronic, magnetic, optical, electromagnetic, infrared, or semiconductor system, apparatus, or device, or any suitable combination of the foregoing. The memory 214 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 214 may comprise any storage means (e.g., devices) suitable for retrievably storing machine-readable instructions 216 executable by processing unit 212.

In one embodiment, the method 100 may be implemented by the computing device 210 in a client-server model (not shown) in which the modelling ANN is provided at the server-side and the candidate ANN at the client-side. In this embodiment, the server-side RSM model is agnostic of client-side activities related to candidate ANN data set, training, hyper-parameters, and the like. In this manner, the client-side exploration of arbitrary machine learning models may be facilitated.

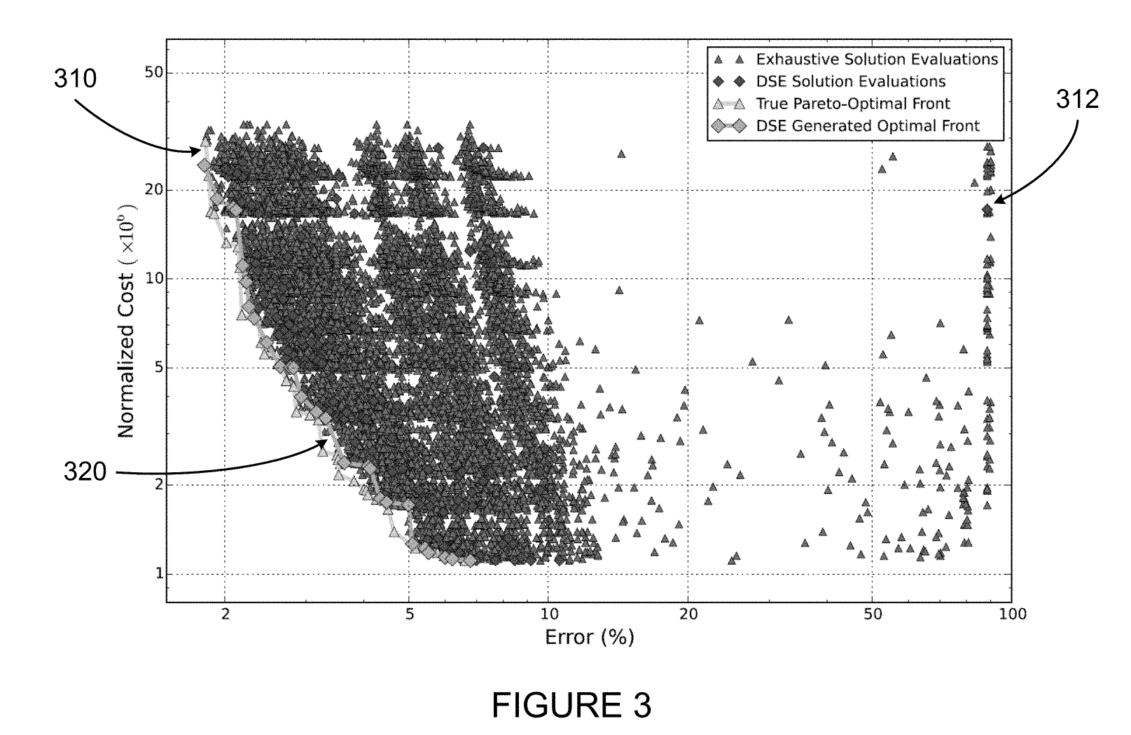

With reference to FIG. 3, an example trial can be performed to assess the method 100. In this example, the trial compares experimental results produced by execution of the method 100 to an exhaustive search targeting a design of an MLP ANN model. For instance, the ANN may be for performing image recognition of handwritten characters from the MNIST (Modified National Institute of Standards and Technology) dataset. In order to make an exhaustive search tractable, a design space for the trial is limited to a particular subset, for instance a design space of 10⁴ solutions, all of which are trained and tested.

In FIG. 3, each triangle represents an individual ANN forming part of the design space. The ANNs are ranked along two axes, namely accuracy (Error %) and performance (Normalized Cost). After evaluating all possible ANN in the design space, a true Pareto-optimal front 310 can be established, illustrated by the line of linked triangles 310.

The method 100 can be used to estimate the true Pareto-optimal front 310. As per step 102, a candidate ANN, having associated set of ANN parameters, for example the ANN 312, is selected. The ANN 312 is illustrated with a diamond to indicate that it is used as a candidate ANN as part of the method 100. The method 100 then proceeds with the following steps 104 to 112 of method 100 to locate the ANN 312 within the graph of FIG. 3. The method 100 can then return to step 102 from decision step 114 and select a new candidate ANN. Each of the candidate ANNs are marked with a diamond in FIG. 3.

As the method 100 continues iterations, new candidate ANNs are tested and the estimated optimal front is continually updated with new candidate ANNs. After a predetermined number of iterations, the estimated optimal front 320 is established. For example, 200 iterations are performed. As illustrated by FIG. 3, the estimated optimal front 320 approximates the Pareto-optimal front 310. Thus, any candidate ANN forming part of the estimated optimal front 320 can be used as a suitable ANN for the application in question.

In some embodiments, the methods and systems for identifying a neural network suitable for a given application described herein may be used for ANN hyper-parameter exploration. In some embodiments, the methods and systems described herein may also be used for DNN compression, specifically ANN weight quantization including, but not limited to, per-layer fixed-point quantization, weight binarization, and weight ternarization. In some embodiments, the methods and systems described herein may also be used for ANN weight sparsification and removal of extraneous node connections, also referred to as pruning. It should be understood that other applications that use neural networks or machine learning, especially applications where it is desired to reduce implementation cost, may apply.

The methods and systems for identifying a neural network suitable for a given application described herein may be implemented in a high level procedural or object oriented programming or scripting language, or a combination thereof, to communicate with or assist in the operation of a computer system, for example the computing device 210. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 212 of the computing device 210, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A method for identifying at least one neural network suitable for a given application, comprising:
selecting a candidate set of neural network parameters associated with a candidate neural network;
predicting at least one performance characteristic of the candidate neural network;
comparing the at least one performance characteristic of the candidate neural network against a current performance baseline; and
when the at least one performance characteristic exceeds the current performance baseline, using a predetermined training dataset for training and testing the candidate neural network to identify the at least one suitable neural network.

2. The method of claim 1, wherein the at least one performance characteristic of the candidate neural network is predicted using a modelling neural network.

3. The method of claim 1, wherein the candidate set of neural network parameters comprises at least one of a number of layers, a number of nodes per layer, a convolution kernel size, a maximum pooling size, a type of activation function, and a network training rate.

4. The method of claim 1, wherein predicting the at least one performance characteristic comprises predicting an average error and at least one of a computation time, a latency, an energy efficiency, an implementation cost, and a computational complexity of the candidate neural network.

5. The method of claim 4, wherein predicting the at least one performance characteristic comprises using a multi-layer perceptron (MLP) model to model a response surface relating the candidate set of neural network parameters to the average error.

6. The method of claim 1, wherein the at least one performance characteristic is compared against the current performance baseline comprising a current Pareto-optimal front composed of one or more performance characteristics of one or more previous candidate neural networks.

7. The method of claim 2, further comprising, when the at least one performance characteristic exceeds the current performance baseline, updating the modelling neural network based on the candidate neural network, comprising retraining the modelling neural network with at least one actual performance characteristic obtained upon testing the candidate neural network and with one or more performance characteristics obtained upon testing one or more previous candidate neural networks.

8. The method of claim 1, further comprising, when the at least one performance characteristic does not exceed the current performance baseline, discarding the candidate neural network.

9. The method of claim 1, further comprising iteratively performing the steps of claim 1 until an iteration limit is attained.

10. The method of claim 1, further comprising:
comparing at least one actual performance characteristic of the candidate neural network against the current performance baseline, the at least one actual performance characteristic obtained upon testing the candidate neural network; and
when the at least one actual performance characteristic exceeds the current performance baseline, updating the current performance baseline to include the at least one performance characteristic.

11. A system for identifying at least one neural network suitable for a given application, comprising:
a processing unit; and
a non-transitory computer-readable memory communicatively coupled to the processing unit and comprising computer-readable program instructions executable by the processing unit for:
selecting a candidate set of neural network parameters associated with a candidate neural network;
predicting at least one performance characteristic of the candidate neural network;
comparing the at least one performance characteristic of the candidate neural network against a current performance baseline; and
when the at least one performance characteristic exceeds the current performance baseline, using a predetermined training dataset for training and testing the candidate neural network to identify the at least one suitable neural network.

12. The system of claim 11, wherein the program instructions are executable by the processing unit for predicting the at least one performance characteristic of the candidate neural network using a modelling neural network.

13. The system of claim 11, wherein the program instructions are executable by the processing unit for selecting the candidate set of neural network parameters comprising at least one of a number of layers, a number of nodes per layer, a convolution kernel size, a maximum pooling size, a type of activation function, and a network training rate.

14. The system of claim 11, wherein the program instructions are executable by the processing unit for predicting the at least one performance characteristic comprising predicting an average error and at least one of a computation time, a latency, an energy efficiency, an implementation cost, and a computational complexity of the candidate neural network.

15. The system of claim 14, wherein the program instructions are executable by the processing unit for predicting the at least one performance characteristic comprisingusing a multi-layer perceptron (MLP) model to model a response surface relating the candidate set of neural network parameters to the average error.

16. The system of claim 11, wherein the program instructions are executable by the processing unit for comparing the at least one performance characteristic against the current performance baseline comprising a current Pareto-optimal front composed of one or more performance characteristics of one or more previous candidate neural networks.

17. The system of claim 12, wherein the program instructions are executable by the processing unit for, when the at least one performance characteristic exceeds the current performance baseline, updating the modelling neural network based on the candidate neural network, comprising retraining the modelling neural network with at least one actual performance characteristic obtained upon testing the candidate neural network and with one or more performance characteristics obtained upon testing one or more previous candidate neural networks.

18. The system of claim 11, wherein the program instructions are executable by the processing unit for discarding the candidate neural network when the at least one performance characteristic does not exceed the current performance baseline.

19. The system of claim 11, wherein the program instructions are executable by the processing unit for iteratively performing the steps of claim 11 until an iteration limit is attained.

20. The system of claim 11, wherein the program instructions are executable by the processing unit for:
comparing at least one actual performance characteristic of the candidate neural network against the current performance baseline, the at least one actual performance characteristic obtained upon testing the candidate neural network; and
when the at least one actual performance characteristic exceeds the current performance baseline, updating the current performance baseline to include the at least one performance characteristic.
